(19) United States
(12) Patent Application Publication
(10) Pub. No.: US 2007/0078700 A1
(43) Pub. Date: Apr. 5, 2007

(54) Systems and methods to facilitate product market management

(76) Inventors: Olaf Lenzmann, Berlin (DE); Kay Iversen, Berlin (DE); Elizabeth Parsons Morgan, Berlin (DE)

Correspondence Address: SUTHERLAND ASBILL & BRENNAN LLP, 999 PEACHTREE STREET, N.E., ATLANTA, GA, 30309, US

(21) Appl. No.: 11/243,152

(22) Filed: Oct. 4, 2005

(51) Int. Cl. G07G 1/00

(52) U.S. Cl. 705/10

(57) ABSTRACT

The present invention is directed to automated computer-based product market management. A system for supporting product market management is provided, the system configured to receive market information items and to document received market information items in a database, and mutually relating the received market information items; receive information on product decisions and to document received information on product decisions in the database; receive information on dependencies of the product decisions, wherein the dependencies are based on at least one of the market information items and at least one of the product decisions, and to document the information on dependencies in the database; provide access to the database to review the information items for support of the product decisions to identify gaps therein; and initiate a market research request to fill at least one identified gap in the market information items.

### BACKGROUND OF THE INVENTION

1. Field of the Invention

The present invention relates to the field of computer-based product market management. More specifically, the invention is concerned with an integrated system and method that incorporates the documentation of market information, the making of decisions in the areas of product opportunity evaluation, product portfolio, product strategy, product planning, product marketing, market analysis, and the guidance of market research according to the information needs of such decisions, and the evaluation of the impact of changes in market information on such decisions.

2. Description of Prior Art

In prior art, various techniques exist to centrally document market information by capturing market research results in documents that are structured according to pre-defined templates and storing such documents in document, content, and knowledge management systems for structured access and searching.

Also, various techniques exist to facilitate communication between the suppliers of market information and decision makers, who use such information, by employing email or other collaborative mechanisms, such as messaging or screen sharing, as vehicle for communication. When integrated with above document, content, and knowledge management systems, such communication techniques enable the notification of users when changes to a document occur and they enable collaborative work on a shared document.

However, these techniques are not designed to structure market information at the level of detail required by specific decisions in product management; specifically, they operate with too coarse a granularity of information, combining many distinct information items into one research document, such that decision makers are forced to search for information that is relevant for a specific decision within such documents and to manually correlate and compile the information found across multiple such documents.

Also, such techniques do not incorporate a model of which types of market information items and historic product decisions should constitute a relevant a-priori influence on a specific type of product decision that is yet to be made, leaving it to the user to correctly identify and assess the information basis for a decision. For example, such model would incorporate knowledge about the fact that “The pricing decision for a product should be influenced by the pricing of competitive products, the production cost of the product, and the opportunity cost associated with the problem that the product solves”. Lacking this knowledge, such techniques are not able to automatically present and analyze the relevant information for a specific product decision.

Further, such techniques fail to systematically document the a-posteriori dependencies of a product decision on the specific market information items and prior product decisions that it relies on; therefore, they are neither able to initiate research of missing or insufficient market information in order to support product decisions, nor can they perform a qualified identification (such as ranking the relevance) of affected product decisions when prior decisions or market information items change.

Finally, such techniques do not capture and systematically assess the quality of market information that is being documented, for example with regard to the source, age, relevance, or completeness of the information. Consequently, such techniques are not able to provide assessments of the quality of the information that serves as basis of a decision.

Due to the limitations outlined above, such prior art techniques require upfront documentation of a rich set of information, which must later be explicitly searched for and retrieved by users to serve as basis for decisions. This amounts to a “push” model, where information is documented and stored in a repository for potential use later in the process. In contrast, in a “pull” model information is specifically requested and documented as needed by specific decisions throughout the decision making process. This approach is generally more desirable as it does not require up-front data gathering, but immediately directs the process of information gathering based on the information needs of concrete decisions to be made. Thus, all information that is researched and documented is directly supporting the decision making process. Ideally, “push” style information supply is only used to capture existing knowledge and unrequested information items as they become known.

### SUMMARY OF THE INVENTION

The present invention is directed to an improved system and method for automated computer-based product market management. According to one aspect of the invention, a computer-based system for supporting product market management is provided, the system comprising a product market database, and a product market management system in communication with the product market data base and including at least one software module configured to: receive market information items and to document received market information items in the product market database, and mutually relating the received market information items; receive information on product decisions and to document received information on product decisions in the product market database; receive information on dependencies of the product decisions, wherein the dependencies are based on one or more of at least one of the market information items and at least one of the product decisions, and to document the information on dependencies in the product market database; provide access to the product market database to review the information items stored in the product market database for support of the product decisions to identify gaps therein; and initiate a market research request to fill at least one identified gap in the market information items.

According to another aspect of the invention, a computer-readable medium having computer readable instructions for managing market information and product decisions is provided, the computer-executable instructions comprising instructions for receiving market information items, documenting received market information items in a product market database, and mutually relating said received market information items; receiving information on product decisions and documenting the received information on product decisions in the product market database; receiving information on dependencies of product decisions on at least some of the received market information items or at least one product decisions, and documenting the information on dependencies of product decisions in the product market database; providing access to the product market database for reviewing information items stored in the product market database to support product decisions to identify gaps therein; and initiating a market research request to fill at least one of the gaps in the received market information items to identify gaps therein.

The present invention introduces an integrated product market management methods and systems that solves the prior art problems described above and therefore constitutes a significant advance in the state of the art. The invention resolves the prior art problems by introducing a method to support concrete product decisions—such as the prioritization of product features—with a specifically tailored, high-quality basis of relevant market information, to drive targeted market research based on the information needs of concrete product decisions that are being made, and to identify the impact of changes in market information on historic product decisions.

The product market management methods and systems include the documentation of market information items within a central repository, also referred to herein as the product market database. The description of market information items is preferably performed on a fine-grained level, where individual information items may for example be a market need, defined with respect to a specific user role in the scope of an organization, caused by a market problem in a certain market segment, implying specific opportunity cost. Each of these items can be independently described and mutually related. The qualification of market information items is performed with respect to the source, age, relevance, completeness, modality (e.g. “belief” or “hypothesis”) of the information, and possibly other criteria.

Implementations may include one or more of the following features: a step-by-step guide (a ‘wizard’) that directs a user supplying information to the appropriate input forms and that identifies related market information by asking a series of questions on the nature and scope of the information that is to be supplied; optional qualification of market information items, treating unqualified information as of “unknown” source, age, etc.

The product market management method and system may include a pre-configured model of weighted influences of types of market information items and prior product decisions on other types of product decisions. For example, such model may express that “The pricing decision for a product should be influenced significantly by the pricing of competitive products, to a lesser degree by the production cost of the product, and the marginally by the opportunity cost associated with the problem that the product solves”. Thus, the method of the invention is able to identify which information is relevant to a specific product decision, relieving the user from a manual screening and selection process; even further, the method of the present invention supports a “pull” model of information, because it can identify which relevant information is not available for a given product decision and initiate according research.

Implementations may include one or more of the following features: the ability to change or augment the model of weighted influences at deployment or at run-time; a multitude of qualifications of modeled influences, for example with respect to importance of the influence; various weighting schemes to rank the importance of missing information.

In another embodiment, the product market management method and system may include the analysis of market information stored in a central repository, the documentation of hypotheses for missing market information items, and the documentation of product decisions based on market information and prior product decisions, including the documentation of the dependencies of a decision on individual market information items and prior product decisions. Implementations may include one or more of the following features: provision of a multitude of product decision templates that provide pre-configured links to the market information items and prior product decisions required to make such decisions; explicit selection of market information items and prior product decisions to support a specific decision; automated analysis of the quality of market information items based on the qualifications described above; explicit initiation of market research requests to research missing market information items and to substantiate inadequate market information items; qualification of the importance of the dependency of market information items and prior product decisions for a specific product decision.

In another embodiment, the product market management method and system may include the guidance of market research and the analysis of the impact of new or changed market information items and product decisions with respect to existing product decisions.

Implementations may include one or more of the following features: a work list for market researchers that provides a prioritized list of market information items to be researched; system guided identification and assignment of target communities (such as specific customers groups) to interview for obtaining market information; generation of questionnaires from a template library to be used in such interviews, focusing on the market information items to research; automatic identification of product decisions that are affected by new or changed market information items or product decisions and notification of users that are involved in such affected product decision; weakest link analysis in a sequence of product decisions to identify the market information items with biggest impact.

In a general aspect, a product market management system in accordance with an aspect of the present invention may include a computer system, hosting a product market database, a set of product market management services, and a portal accessible via a network. A multitude of clients can access the product market management system via the network.

### BRIEF DESCRIPTION OF THE DRAWINGS

FIG. 1 is a block diagram illustrating an integrated product market management system in accordance with an embodiment of the present invention.

FIG. 2 is a block diagram illustrating exemplary interaction of information suppliers and decision makers with an integrated product market management system in accordance with an embodiment of the present invention.

FIG. 3 is a flow diagram showing the sequence of actions to enter market information into an integrated product market management system in accordance with an embodiment of the present invention.

FIG. 4 is a flow diagram showing the sequence of actions to make product decisions within an integrated product market management system in accordance with an embodiment of the present invention.

FIG. 5 is a flow diagram showing the sequence of actions to perform market research directed by an integrated product market management system in accordance with an embodiment of the present invention.

FIG. 6 is a flow diagram showing the sequence of actions to review product decisions within an integrated product market management system, triggered by changes in the information basis of the decision.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is described below with reference to block diagrams and flowchart illustrations of systems, methods, apparatuses and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

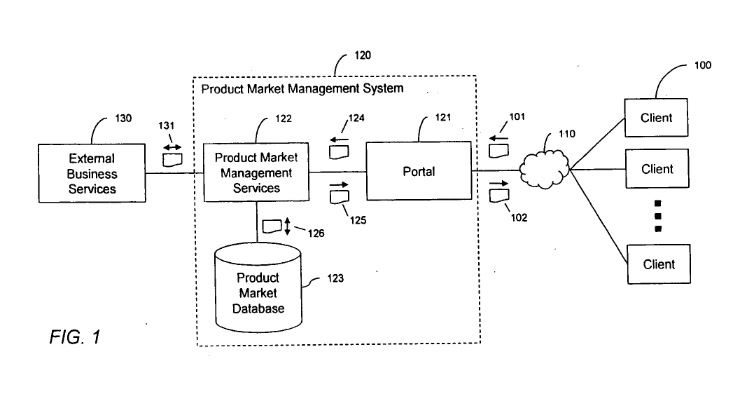

Exemplary embodiments of the present invention will hereinafter be described with reference to the figures, in which like numerals indicate like elements throughout the several drawings. FIG. 1 shows a block diagram of an integrated product market management system according to one aspect of the present invention. In particular, FIG. 1 is an exemplary operating environment for implementation of certain embodiments of the present invention, including clients 100, a product market management system 120 and external business services 130, which are each configured for accessing and reading associated computer-readable media having stored thereon data and/or computer-executable instructions for implementing the various methods of the present invention. Generally, network devices and systems include hardware and/or software for transmitting and receiving data and/or computer-executable instructions over a communications link and a memory for storing data and/or computer-executable instructions. Network devices and systems may also include a processor for processing data and executing computer-executable instructions, as well as other internal and peripheral components that are well known in the art. As used herein, the term “computer-readable medium” describes any form of memory or a propagated signal transmission medium. Propagated signals representing data and computer-executable instructions are transferred between network devices and systems.

With further reference to FIG. 1, the system 120 comprises a portal 121, a set of product market management services 122, and a product market database 123, each of which is hosted on and executed by a data processing system, which is preferably realized by one or multiple connected microcomputers, such as an ensemble of network servers, executing software in accordance with the present invention.

The portal 121 provides a common interface to the product market management system 120, to which a multitude of clients 100 can be connected over a network 110. The network 110 can be a local area network (LAN), wide area network (WAN), enterprise network, virtual private network (VPN), the Internet, and the like. The clients 100 are preferably realized by microcomputers, such as personal computers each having a monitor for displaying computer screens and a keyboard or other device for providing input. Clients 100 send requests 101 to the portal 121, which send data views 102, such as web pages, in response. The portal 121 communicates with the set of product market management services 122: the portal 121 sends request data 124 to the product market management services 122 and receives response data 125 in order to fulfill the requests from clients 100. The set of product market management services 122 communicates with a product market database 123, storing and retrieving data 126 in, respectively from the database. The data stored in such product market database 123 includes market information items, product decisions and their drivers, and a pre-configured model of influences of types of market information items and prior product decisions on other types of product decisions.

The set of product market management services 122 may or may not be connected to external business services 130 to submit or retrieve various types of data 131. The external business services 130 can include various application services, such as electronic file or mail systems, user directory and authentication systems, and business intelligence systems. The product market management system 120 can integrate and interact with the data and functionality of such external business services 130.

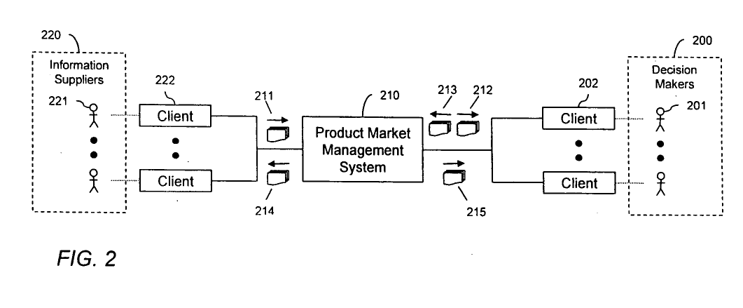

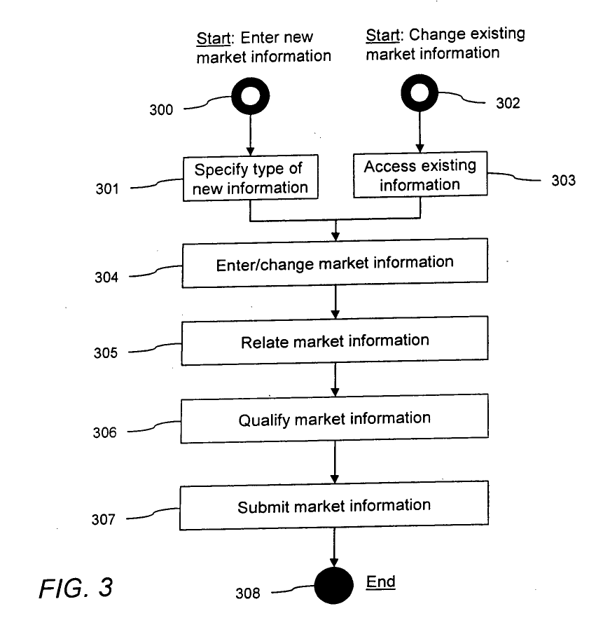

FIG. 2 is a block diagram that illustrates the interaction of the communities of information suppliers 220 and decision makers 200 with the product market management system 210. A user 221 from the community of information suppliers 220 makes use of a client 222 to connect to and interact with the product market management system 210. Using the client 222, a user 221 submits a multitude of market information items 211 to the product market management system 210. Such submission of market information items by the community of information suppliers 200 is performed following the sequence of actions illustrated in FIG. 3.

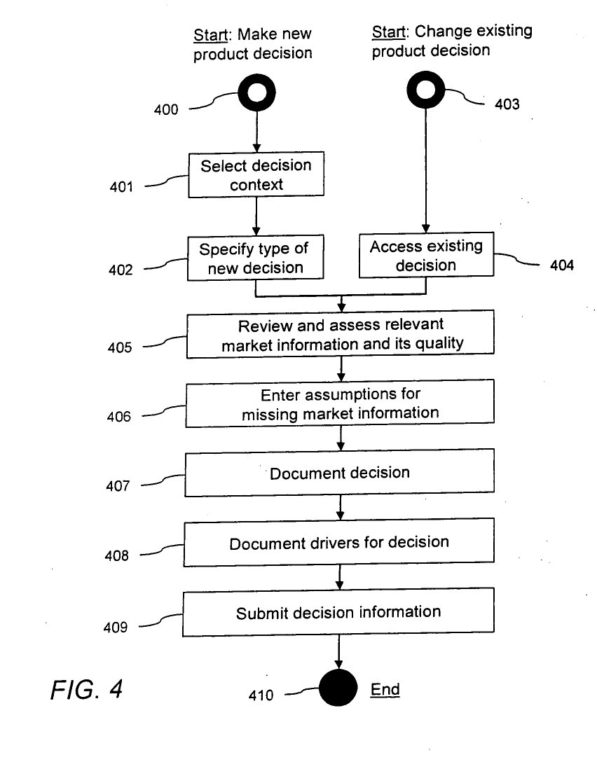

A user 201 from the community of decision makers 200 makes use of a client 202 to connect to and interact with the product market management system 210. Using the client 202, the user 201 retrieves data 212 from the product market management system 210, including market information items, prior product decisions, and information derived thereof, such as reports and analyses. Subsequently, the user 201 makes a product decision and submits data 213 to the product market management system 210, documenting the product decision and its dependencies on the data items 212 retrieved previously. Also, the set of data 213 submitted by the user 201 may include a documentation of hypotheses for missing market information items that were not contained in the set of data 212. This interaction between the community of decision makers 200 and the product market management system 210 is performed following the sequence of actions illustrated in FIG. 4.

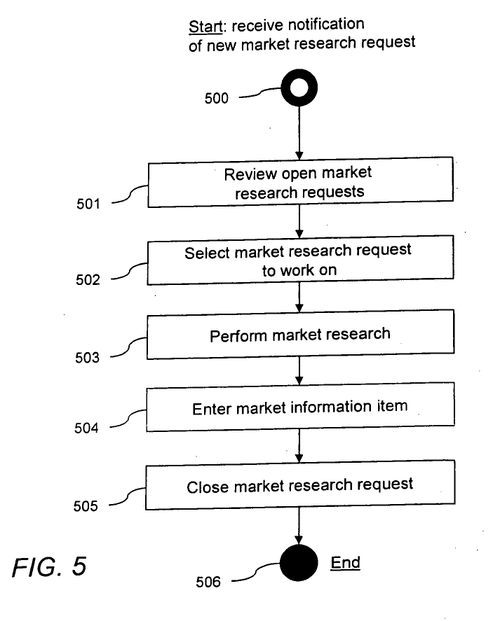

The product market management system 210 automatically generates market research requests 214 for the community of information suppliers 220, based on product decisions and their dependencies on market information items that have been documented in data sets 213. For example, a user 201 may have documented a decision concerning which finctionality is to be included in a product and may have specified that a certain set of market requirements, descriptions of which are stored in the product market management system 210, have lead to this decision; when the product market management system 210 scans the information stored in its repository and finds that the documentation of said market requirements is outdated or otherwise of inadequate quality, it automatically creates a new market research request to substantiate the description of said market requirements. A user 221 from the community of information suppliers 220 retrieves such market research requests 214 by using the client 222 to connect to the product market management system 210. The delivery of market research requests 214 to the client 222 of the user 221 may either follow a “push mode”, where market research requests 214 are immediately sent to the client 222 and displayed to the user 221, as soon as the client connects to the system, or a “pull mode”, where a user 221 explicitly performs an action within the user interface of the client 222 to query the product market management system for new market research requests 214. After a user 221 has researched the requested information, data sets 211 with the respective information are submitted to the product market management system 210, as described above. This interaction between the community of information suppliers 220 and the product market management system 210 is performed following the sequence of actions illustrated in FIG. 5.

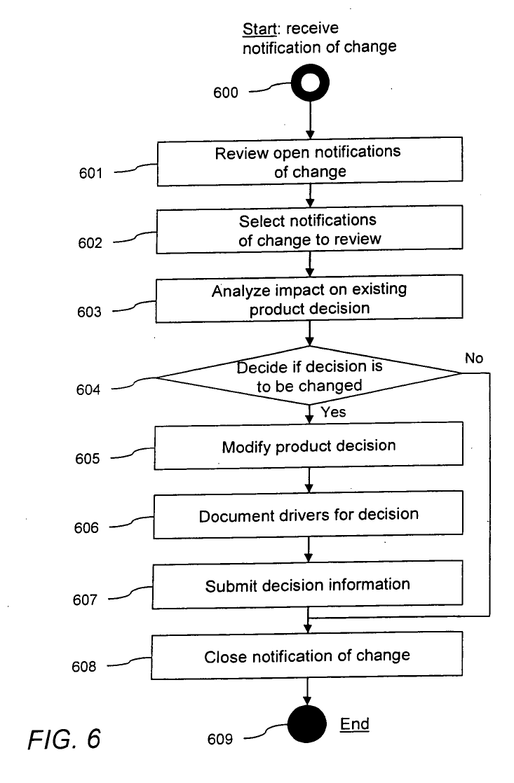

Upon submission of market information items 211 or product decisions 213, the product market management system 210 automatically scans all documented product decisions and their dependencies, in order to identify those product decisions of which the decision basis has changed by the newly submitted market information items or product decisions. For example, a user 201 may have documented a decision concerning which functionality is to be included in a product and may have specified that a certain set of market requirements, descriptions of which are stored in the product market management system 210, have lead to this decision; when the description of said market requirements is updated in the system, this implies a change to the basis of said product decision. The product market management system 210 generates notifications of change 215 for each impacted product decision to notify those users from the community of decision makers 200 that have made or were involved in the respective product decision. A user 201 from the community of decision makers 200 retrieves such notifications of change 215 by using the client 202 to connect to the product market management system 210. The delivery of notifications of change 215 to the client 202 of a user 201 may either follow a “push mode”, where notifications of change 215 are immediately sent to the client 202 and displayed to a user 201, as soon as the client connects to the system, or a “pull mode”, where a user 201 explicitly performs an action within the user interface of the product market management system to query for new notifications of change 215. After the user 201 has reviewed and analyzed the impact of a change in market information items or prior product decisions as indicated by a notification of change 215, the affected product decision may or may not be revised; in the case of revision, an updated documentation 213 of the decision is submitted to the product market management system 210. Such revision of product decisions may in turn trigger market research requests 214, as described above. This interaction between the community of decision makers 200 and the product market management system 210 is performed following the sequence of actions illustrated in FIG. 6.

FIG. 3 is a flow diagram that shows the sequence of actions performed to submit market information items to the product market management system.

The sequence starts when a user who wants to document a new market information item (start 300) invokes an appropriate command in the user interface of the product market management system, for example by selecting a menu item “document new market information”, and subsequently supplies information on the type of the market information item to be documented (step 301). In the preferred embodiment, this can be accomplished by either selecting the appropriate information type (such as “market need”, “competitor”, etc.) from a pre-defined list displayed in the user interface of the product market management system, or by following a step-by-step guide, which asks a series of questions to identify the proper information type. Upon selection of the type, the product market management system provides one or a series of suitable input forms to document the market information item, which forms generally consist of a set of text input, number input, and selection fields.

Alternatively, the sequence may start when a user who wants to change existing documentation of a market information item (start 302) selects the information item to change by means of navigating data structures in the system (step 303), e.g. by navigating a hierarchical tree-structure of competitor information in the user interface of the product market management system, selecting the appropriate item and performing an “edit” action to obtain one or a series of suitable input forms to change the existing information.

In both cases, the user enters or changes the market information item (step 304) in textual or numeric representation in the forms obtained from steps 301 or 303, respectively. Subsequently, the user relates the market information item to other relevant market information items (step 305), by creating references to those other market information items. For example, this may include specifying which market segments are affected when documenting a market need. In the preferred embodiment, the selection of the market information items to reference may either be performed by means of data navigation in the user interface, or by following a step-by-step guide, asking a series of questions and finally presenting a small set of alternative market information items to choose from.

In the next step, the user qualifies the documented market information item (step 306); in the preferred embodiment, this qualification is performed by specifying the source, age, completeness, relevance, and modality (e.g., “hypothesis”, “belief”, “knowledge”) of the information in appropriate input fields. Optionally, the user may choose to skip this step, in which case the qualification of the item is treated as “unknown” when assessing information quality.

Finally, all data that have been entered in the preceding steps (304 through 306) are submitted to the product market management system (step 307) for storage and processing, effectively performing steps 304 through 306 in a single transaction, and the sequence ends (end 308). In the preferred embodiment, the product market management system automatically processes all submitted market information items to identify their impact on existing product decisions, generating notifications of change to trigger the sequence of action described in FIG. 6 for the affected product decisions.

FIG. 4 is a flow diagram that shows the sequence of actions performed to retrieve market information items from the product market management system and to document product decisions.

The sequence starts when a user who wants to make a product decision (start 400) invokes an appropriate command in the user interface of the product market management system to specify the context of the decision to be made (step 401), for example by selecting the product for which a decision is to be made from a global list of products displayed in the user interface of the product market management system.

Subsequently, the user invokes an appropriate command in the user interface of the product market management system to initiate a new product decision (step 402). For example, this can be achieved by selecting the appropriate type of decision (such as “define target market”, “select product features for next release”, etc.) from a pre-defined list.

Alternatively, the sequence may start when a user who wants to change an existing product decision (start 403) selects the product decision to change by means of navigating product decisions that are stored in the system (step 404), e.g. by navigating a hierarchical tree-structure of product decisions, selecting the appropriate decision and performing an “edit” action on it. The selection of an existing product decision implicitly selects that decision's context, thus obviating the need for explicit context selection as required for new decisions in step 401.

In both cases, after the product decision and its context have been specified, the product market management system provides a multitude of data views for review by the user (step 405), presenting market information items and prior product decisions that are relevant to the product decision to be made in the selected context, and also presenting information derived from such market information items. The identification of relevant information to be presented is performed on the basis of the pre-configured model influences of types of market information items and prior product decisions on other types of product decisions, which is embedded into the product market management system. For example, for a “select product features for next release” decision, the system may present the market needs relevant in the context, competitive products addressing these market needs, and most the important features of such competitive products. In the preferred embodiment, an assessment of the information quality is provided by the system, which highlights for example those market information items that are of high importance, but are outdated or only rated with little confidence.

After reviewing the market information provided by the system, the user may or may not identify missing information items and document these (step 406) if required. For example, a user may know that a competitive product exists, but no such market information items would be available in the system. In this case, the user would create a new market information item, following the sequence of actions outlined in FIG. 3, would describe the information item to the best knowledge and qualify it as “hypothesis”. This enables the product market management system to generate according market research requests, which are processed by the information supplier community, as outlined in FIG. 5, in order to supply the missing information.

Based on the available market information obtained in step 405 and the hypotheses on the missing market information established in step 406, the user makes a decision and documents that decision (step 407). This is done by filling in appropriate forms in the user interface of the product market management system, which are specific to the type of product decision made, comprising respective input fields.

Subsequently, the user documents the drivers for the decision that has been made (step 408) by specifying references to those market information items and prior product decisions that have had the most significant impact on the decision. Such references are qualified by the user in terms of the relative importance on the respective decision, thus enabling the product market management system to appraise the impact of changes to market information items and prior product decisions with respect to the documented decision. In the preferred embodiment, the selection of the market information items and prior product decisions to document as drivers may either be performed by means of globally navigating the set of market information and product decision data in the user interface, or by selecting items from the set of information presented by the product market management system for review in step 405.

Finally, all data that have been entered in the preceding steps (407 through 408) are submitted to the product market management system (step 409) for storage and processing, effectively performing steps 407 through 408 in a single transaction, and the sequence ends (end 410).

FIG. 5 is a flow diagram that shows the sequence of actions performed to research market information items as requested by the product market management system.

The sequence starts when a user from the community of information suppliers receives a notification of a new market research request (start 500); such notification may be delivered via email, may be directly indicated by the product market management system to the user by a pop-up window or other display means, or may be supplied by other electronic or non-electronic means. In the first step, the user accesses a list of open market research requests through the user interface of the product market management system and reviews the items in the list (step 501). In the preferred embodiment, such market research requests are prioritized by the system based on an assessment of the quality of the information that is currently available on the affected market information item, taking the age, source, accuracy, modality, and other qualifications of the information item into account, and by the importance of the affected market information item for product decisions that have been made, as documented by the drivers for each of the decisions. Also, in the preferred embodiment market research requests are assigned to specific users or pools of such users from the community of information providers based on various criteria, such as responsibilities for certain types or scopes of market information items, effectively resulting in personalized lists of open market research requests. For example, a certain group of users may be responsible to research competitor information in the scope of a specific product.

Next, the user selects one of the market research requests to work on in the user interface of the product market management system and invokes an action that signals that the user is starting to work on it (step 502), thus marking it as being in progress and preventing other users from working on the same market research request redundantly. In the next step, the user performs market research (step 503) to establish the desired information. This step is performed outside of the product market management system.

After having performed research, the user documents the market information items that have been researched (step 504), following the sequence of actions described in FIG. 3 for each market information item. In the preferred embodiment, the user interface description of the market research requests provides direct links to the input forms for the market information items to be researched, thus cutting short the sequence of actions described in FIG. 3 by effectively skipping steps 301 or 303, respectively. Also, in the preferred embodiment, the documentation of new or changed market information items starts an automated scan of existing product decisions to identify affected product decisions and deliver notifications of change to trigger the sequence of actions described in FIG. 6 for the affected product decisions. Finally, the user closes the market research request (step 505), thus removing it from the list of open market research items, and the sequence ends (end 506).

FIG. 6 is a flow diagram that shows the sequence of actions performed when receiving notification of changes to the information basis of existing product decisions.

The sequence starts when a user from the community of decision makers receives a notification of a change in the information basis of an existing product decision (start 600), either constituted by a change in market information, or by a change in prior product decisions; such notification may be delivered via email, may be directly indicated by the product market management system to the user by a pop-up window or by other display means, or may be supplied by other electronic or non-electronic means.

In the first step, the user accesses a list of open notifications of change through the user interface of the product market management system and reviews the items in the list (step 601). In the preferred embodiment, such notifications of change are prioritized by the system based on the relative importance of the items in the decision basis that have changed, as documented by the drivers for the affected decision. Also, in the preferred embodiment, each notification of change provides a summary of the changes in the decision basis of the product decision that the notification refers to, as well as links to directly access those market information items or prior product decisions that constitute the changes.

Next, the user selects one of the notifications of change for review in the user interface of the product market management system and invokes an action that signals that the user is starting to review on it (step 602), thus marking it as being in progress and preventing other users from reviewing the same notification of change redundantly.

Subsequently, the product market management system presents a multitude of data views to the user that visualize the changed decision basis for the product decision affected by the selected notification of change (step 603). In the preferred embodiment, this step is similar to step 405 performed in the process of making product decisions, as illustrated in FIG. 4, but presents only such information that has been qualified as important driver to the specific decision in step 408. Based on the information presented in the previous step, the user decides whether the product decision needs to be revised (step 604). In case a revision is required, the changed decision is documented by the user (step 605) by altering the decision description in respective forms in the user interface; the changed drivers of the decision are documented (step 606) by updating the description of the drivers of the decision and their relative importance; and the ensemble of changed data is submitted to the product market management system (step 607). This procedure follows the same sequence of actions like for the case of documenting a new product decision, described in steps 407 through 409 in FIG. 4.

Finally, the notification of change that has been reviewed is closed by the user (step 608), thus removing it from the list of open notifications of change, and the sequence ends (end 609).

The features disclosed in this specification, claims and/or the figures may be material for the realization of the invention in its various embodiments, taken in isolation or in various combinations thereof.

1. A computer-based system for supporting product market management, comprising;
a product market database; and
a product market management system in communication with the product market database and including at least one software module configured to:
receive market information items and document the market information items in the product market database, and mutually relate the received information items;
receive information on product decisions and document the information on product decisions in the product market database;
receive information on dependencies of the product decisions, wherein the dependencies are based on one or more of at least one of the market information items and at least one of the product decisions, and document the information on the dependencies in the product market database;
provide access to the product market database to review the information items stored in the product market database for support of the product decisions to identify gaps therein; and
initiate a market research request to fill at least one identified gap in the market information items.

2. The system of claim 1, wherein the product market management system further is configured to deliver the market research request to a client in a push mode, wherein the market research request is automatically provided to the client.

3. The system of claim 1, wherein the product market management system further is configured to deliver the market research request to the client in a pull mode, wherein the market research request is provided to the client after a user query for a new market research request is received.

4. The system of claim 1, wherein the product market management system further is configured to initiate the market research request based at least partially on an evaluation of the documented information on market information items and the documented information on dependencies of product decisions on market information items.

5. The system of claim 4, wherein the evaluation includes an evaluation of at least one of quality, availability and usage of the documented information on market information items.

6. The system of claim 4, wherein the evaluation includes an evaluation of the importance of the documented dependencies of product decisions on market information items.

7. The system of claim 1, wherein the product market management system further is configured to implement a pre-configured model of weighted influences of the received market information items and prior product decisions.

8. The system of claim 1, wherein the product market management system further is configured to assess quality of the received market information items stored in the product market database, wherein quality is based on at least one of age, source, relevance, completeness, and modality of the respective market information items.

9. The system of claim 1, wherein the product market management system further is configured to identify product decisions impacted by a received change of at least one of the market information items and to rank the identified product decisions in the product market database according to a severity of impact.

10. The system of claim 1, wherein the product market management system further is configured to (1) scan the information on product decisions and the information on dependencies of product decisions on market information items in the product market database after receiving a new information item including at least one of a market information item, information on a product decision, and information on a dependencies of a product decision, (2) identify a selected product decision for which a decision basis changed due to the new information item, and (3) generate a notice of change for the selected product decision indicating a changed decision basis.

11. The system of claim 10, wherein the product market management system further is configured to deliver the notice of change to a client in a push mode, wherein the notice of change is automatically provided to a client.

12. The system of claim 10, wherein the product market management system further is configured to deliver the notice of change to a client in a pull mode, where the notice of change is provided to a client after a user query for a new notice of change is received.

13. A computer-readable medium having computer-executable instructions for managing market information and product decisions, the computer-executable instructions comprising instructions for:
receiving market information items, documenting the market information items in a product market database, and mutually relating the received market information items;
receiving information on product decisions and documenting the received information on product decisions in the product market database;
receiving information on dependencies of product decisions on at least one of the received market information items or at least one of the product decisions, and documenting the information on dependencies of product decisions in the product market database;
providing access to the product market database for reviewing market information items stored in the product market database to support product decisions to identify gaps therein; and
initiating a market research request to fill at least one of the identified gaps in the received market information items.

14. The computer-readable medium of claim 13, wherein initiating the market research request comprises:
delivering the market research request to a client in a push mode, wherein the market research request is automatically provided to the client.

15. The computer-readable medium of claim 13, wherein initiating the market research request comprises:
delivering the market research request to a client in a pull mode, wherein the market research request is provided to the client after a user query for a new market research request is received.

16. The computer-readable medium of claim 13, wherein the step of initiating the market research request comprises:
initiating the market research request based at least in part upon an evaluation of the documented information on market information items and the documented information on dependencies of product decisions on market information items in the product market database.

17. The computer-readable medium of claim 16, wherein the step of initiating the market research request comprises:
performing an evaluation of at least one of quality, availability and usage of the documented information on market information items in the product market database.

18. The computer-readable medium of claim 16, wherein initiating the market research request comprises:
performing an evaluation of an importance of documented dependencies of product decisions on market information items in the product market database.

19. The computer-readable medium of claim 13, further comprising instructions for:
implementing a pre-configured model of weighted influences of types of the received market information items and prior product decisions on other types of product decisions.

20. The computer-readable medium of claim 13, further comprising instructions for:
assessing quality of the received market information items stored in the product market database, wherein quality is based on as at least one of age, source, relevance, completeness, and modality of the respective market information item in the product market database.

21. The computer-readable medium of claim 13, further comprising instructions for:
identifying product decisions impacted by a received change of at least one of the received market information items; and
ranking the identified product decisions in the product market database according to a severity of impact.

22. The computer-readable medium of claim 13, further comprising instructions for:
scanning the received information on product decisions, and the received information on dependencies of product decisions in the product market database after receiving a new information item comprising at least one of: market information item, information on product decision, and information on dependencies of product decisions, to identify a selected product decision for which a decision basis changed due to the new information item; and
generating a notice of change for the selected product decision indicating the changed decision basis.

23. The computer-readable medium of claim 22, wherein initiating the market research request comprises:
delivering the notice of change to a client in a push mode, wherein the notice of change is automatically provided to a client.

24. The computer-readable medium of claim 22, wherein initiating the market research request comprises:
delivering the notice of change to a client in a pull mode, wherein the notice of change is provided to the client after a user query for a new notice of change is received.

25. A computer-based method for supporting product market management, comprising;
receiving market information items and documenting the market information items in a product market database, and mutually relating the received information items;
receiving information on product decisions and documenting the information on product decisions in the product market database;
receiving information on dependencies of the product decisions, where the dependencies are based on one or more of at least one of the market information items and at least one of the product decisions, and documenting the information on the dependencies in the product market database;
providing access to the product market database to review the information items stored in the product market database for support of the product decisions to identify gaps therein; and
initiating a market research request to fill at least one identified gap in the market information items.
